(19) United States
(12) Patent Application Publication
(10) Pub. No.: US 2024/0002048 A1
(43) Pub. Date: Jan. 4, 2024

(54) TWIN BOOM VTOL ROTORCRAFT WITH DISTRIBUTED PROPULSION

(71) Applicant: Xi WANG, Saint-Laurent (CA)

(72) Inventor: Xi WANG, Saint-Laurent (CA)

(21) Appl. No.: 17/827,706

(22) Filed: May 28, 2022

(51) Int. Cl. B64C 29/00; B64D 27/26

(52) U.S. Cl. CPC B64C 29/0033; B64C 5/02; B64D 27/26

(57) ABSTRACT

A VTOL (vertical take-off and landing) rotorcraft with distributed propulsion system having the capability to convert to airplane flight. The rotorcraft includes a short fuselage, a pair of wings, a pair of inboard booms, a plurality of outboard booms, an empennage, a plurality of lift rotors, and a plurality of proprotors. The fuselage, the wings, inboard booms and V-tail are mechanically coupled together. The plurality of outboard booms is mounted to the wings. Moreover, the proprotors and lift rotors are mounted on the inboard and outboard boom. The placement of the lift rotors allows the rotorcraft to benefit from the reliable and agile function of the quadcopter. The plurality of proprotors in a first configuration provides additional lift thrust for VTOL flight and a second configuration provides forward propulsive thrust in airplane flight.

### REFERENCE TO RELATED PATENTS

| U.S. Pat. No. | Dec. 2, | John Frederick | B64C11/28, |
|---|---|---|---|
| 6,655,631 B2 | 2003 | Austen-Brown | B64C29/0033 |
| U.S. Pat. No. | Oct. 01, | Charles Justin | B64C29/0008, |
| 9,120,560 B1 | 2015 | Armer | B64C27/26, |
| | | | B64C29/0016, |
| | | | B64C29/0025, |
| | | | B64C39/04 |
| US 2018/0155021 | Jun. 7, | Michael D. | B64C29/0033 |
| A1 | 2018 | Patterson | |
| US 10,364,036 B2 | Jul. 30, | James Joseph | B64D29/02, |
| | 2019 | Tighe | B64C29/0025 |
| US 2021/0362849 | Nov. 25, | BOWER, | B64C29/0033 |
| A1 | 2021 | Geoffrey C. | B64C27/26, |
| | | | B64C27/28, |
| | | | B64C29/00, |
| | | | B64C29/0025 |
| US 11,208,203 | Dec. 28, | Robert W. | B64C27/26 |
| B2 | 2021 | Parks | |
| US 2022/0126996 | Apr. 28, | Geoffrey | B64C29/0033 |
| A1 | 2022 | Alan Long | |

### BACKGROUND OF THE INVENTION

The helicopter is an essential modern air transportation vehicle. Rotorcraft and rotary-wing vehicle are the technical term designated for aircraft equipped with rotating wing, which provides lift, propulsion and steering control. Rotorcraft can land and take-off without the presence of a long runway. However, travelling in a helicopter is expensive, due to the high operational cost. Moreover, helicopter with fossil fuel engine flying over an urban area is known to be a source of noise and air pollution.

The world of aviation is under pressure to reduce emission. As a result, there is numerous new designs of E-VTOL (electrical vertical take-off and landing) rotorcraft in progress, and the term “Air Taxi”, UAM (urban air mobility) or AMM (Advanced Air Mobility) are adopted for this type of personal or cargo aerial transportation. An E-VTOL rotorcraft is quiet, emission free and low operational cost.

As the traffic is increasingly congested in the global urban area, an affordable E-VTOL rotorcraft is the solution for daily commuter to avoid the congestion on the road. Without traffic delay, an affordable E-VTOL rotorcraft can also serve as law enforcement vehicle, ambulance and medical cargo transporter.

Since the weight of electrical energy storage accounts for a large fraction of the total weight of the E-VTOL rotorcraft, it is paramount to design an electrical rotorcraft with higher propulsive thrust and lift thrust efficiency. The electrical energy storage for electrical rotorcraft is not limited to electrical battery or fuel cell. Based on the momentum theory of propeller, small disc area with high disc loading leads to lower lift thrust efficiency. Therefore, higher power is required to lift the rotorcraft and more energy is consumed to hover. The best demonstration of this theory can be found in human powered rotorcraft. The human powered rotorcraft with multiple giant rotors is as large as the size of a basketball court. The disc area must be very large, in order to reduce the disc loading and increase lift thrust efficiency, therefore a person can provide the required power to hover the rotorcraft. However, long light weight rotor blade has limited strength and non-practical for landing on a small area. Moreover, the longer rotor blade increases of the risk of impact surrounding obstacle and human.

### SUMMARY OF THE INVENTION

The primary objective of the present invention is to disclose a VTOL rotorcraft with distributed propulsion, which is suitable for larger and heavier aerial vehicle application. The distributed propulsion includes at least four lift rotors and at least four proprotors to benefit from the reliable and agile function of a quadcopter. The proprotors provide lift thrust and flight forward thrust. Moreover, the four lift rotors can be stowed during horizontal flight to reduce drag.

1. In one embodiment of the VTOL rotorcraft is provided, comprising of the fuselage, the opposing wing, a pair of opposing inboard booms, at least one pair of opposing outboard booms, an inverted V-tail, a plurality of proprotors, and a plurality of lift rotors.

2. In one embodiment of the VTOL rotorcraft is provided, comprising of the fuselage, the opposing wing, a pair of opposing inboard booms, at least one pair of opposing outboard booms, a high-tail, a plurality of proprotors, and a plurality of lift rotors.

### OBJECT OF THE INVENTION

The primary object of the present invention is an aerial vehicle with the capability to convert between VTOL flight to airplane flight.

### PRIOR ART

Traditionally, helicopter is equipped with a single large rotor for lift, propulsion and steering control. Helicopter is distinctive by the tail rotor to balance the torque effect of the main rotor. A significant amount of energy is wasted in the tail rotor in hover and low-speed flight. In order to eliminate the need for the tail rotor, the contra-rotating rotors were introduced in helicopter design. The contra-rotating rotors can balance the torque effect and increase power without increase in disc frontal diameter. A light weight civilian helicopter with large main rotor is known to have lower disk loading. As a result, the lift thrust efficiency is the highest among the VTOL (vertical take-off and landing) vehicle. The fact that helicopter has large main rotor with high inertia, it is not possible to modulate the rotational speed to vary the output thrust. As a result, helicopter's rotor operates at constant speed, and the pitch of the rotor blade is changed by the swash plate mechanism. The swash plate mechanism is linked to the collector and cyclic to steer the helicopter, which is a complex and heavy equipment. Naturally, both single rotor or contra-rotating rotary wings have the complex mechanical swash plate system.

The arrival of distributed electrical propulsion system allows modern multirotor to substitute the single main rotor helicopter. The electrical propulsion system is equipped with multiple independent rotors of smaller disc area to provide lift, propulsion and steering control. Quad-rotorcraft is a popular design for electrical rotorcraft, since it contains four moving parts, which are the four rotating rotors. The fixed pitch rotor with small diameter has low inertia, therefore it can rapidly change the output thrust by modulating the rotational speed of the rotor. The change of the output thrust of the four rotors creates the thrust vector for lift, propulsion and steering control. The distributed electrical propulsion architecture decreases rotor loading by increasing the number of lift rotor.

Advantageously, VTOL (vertical take-off and landing) vehicle can operate without a runway. However, an aerial vehicle operating in VTOL mode requires significantly higher amount of energy than an airplane with fixed wing to maintain forward flight. Therefore, the usefulness of the VTOL vehicle is limited to short-range flight. The modern VTOL vehicle is commonly designed with electrical power plant. In order to reduce the weight of electrical energy storage, a viable VTOL vehicle can adapt to airplane mode for long range forward fight. The proprotor is a rotor which can provide lift thrust and forward thrust. The proprotor has the advantage to reduce drag during horizontal flight and reduce the overall weight of the rotorcraft. FIG. 11 provides examples of designs known to the art from Archer Aviation 1000, Wisk Aero 1001 and Vertical Aerospace 1002. The examples depict a VTOL vehicle design with a plurality of booms coupled on the wings, and the booms are provided with a plurality of proprotors and a plurality of lift rotors. In this example, a plurality of proprotors is positioned forward of the center of gravity and a plurality of lift rotors is positioned aftward of the center of gravity. Consequently, from the failure of the plurality of proprotors, the plurality of lift rotors alone is inadequate to provide flight control authority to the vehicle in the pitch plane.

### BRIEF DESCRIPTION OF DRAWINGS

It should be observed that three mutual orthogonal directions X, Y, and Z are shown in some of the FIGS. The first direction X is said to be “longitudinal”, and the forward side is referenced to be positive. A rotational movement around the longitudinal direction is known as roll. The second direction Y is said to be “transverse”, and the port side is referenced to be positive. A rotational movement around the transverse direction is known as pitch. Finally, the third direction Z is said to be “vertical”, and the up side is referenced to be positive. A rotational movement around the vertical direction is known as yaw. Moreover, it should be observed that force vector is shown in dash lead arrow and the direction of movement is shown in bold lead arrow.

FIG. 1 shows a perspective view of the embodiment of the twin boom rotorcraft in VTOL mode and hover mode.

FIG. 2 shows a top orthogonal view of the embodiment of FIG. 1.

FIG. 3 shows a perspective view of the embodiment of FIG. 1 with forces acting thereon.

FIG. 4 shows a perspective view of the embodiment of the twin boom rotorcraft in airplane mode with forces acting thereon.

FIG. 5 shows a back orthogonal view of the embodiment of the twin boom rotorcraft in landed configuration.

FIG. 6 shows a perspective view of another embodiment of the twin boom rotorcraft in VTOL mode and hover mode.

FIG. 7 shows a perspective view of the embodiment of FIG. 6 with forces acting thereon.

FIG. 8 shows a perspective view of the embodiment of the twin boom rotorcraft in airplane mode with forces acting thereon.

FIG. 9 shows a side orthogonal view of the embodiment of an optional configuration of the inboard boom provided with the lift rotor.

FIG. 10 shows a side orthogonal view of the embodiment of an optional configuration of the outboard boom provided with the lift rotor.

FIG. 11 are photos of existing or proposed VTOL rotorcraft design known in the art.

### DETAILED DESCRIPTION OF THE INVENTION

Regarding the invention disclosure, the feature and advantage of the invention are particularly pointed and distinctly claimed in the claims. Detailed description and methods are given to provide further comprehension of the functionality of the invention. In the disclosure of the invention, the technical term “rotor” is referred as the rotating blade with airfoil to generate thrust by moving air. Moreover, the technical term “proprotor” is referred as the rotating blade with airfoil to generate thrust by moving air as an airplane-style propeller and helicopter-style rotor. Moreover, the term “opposing” is used to describe a component, feature, or element which is symmetrical with respecting to median plane of the rotorcraft. It is further understood that the terms “includes”, “including”, “comprises”, “comprising”, “couples”, ‘coupled”, “mounts”, and “mounted”, when used herein, specify the presence of stated features, components and elements, without the further detail on the method of mechanical interconnexion. In addition, it is also understood that the singularity form “a”, “an”, and “the” used throughout the description are intended to includes plural forms as well, unless the context clearly specifies otherwise.

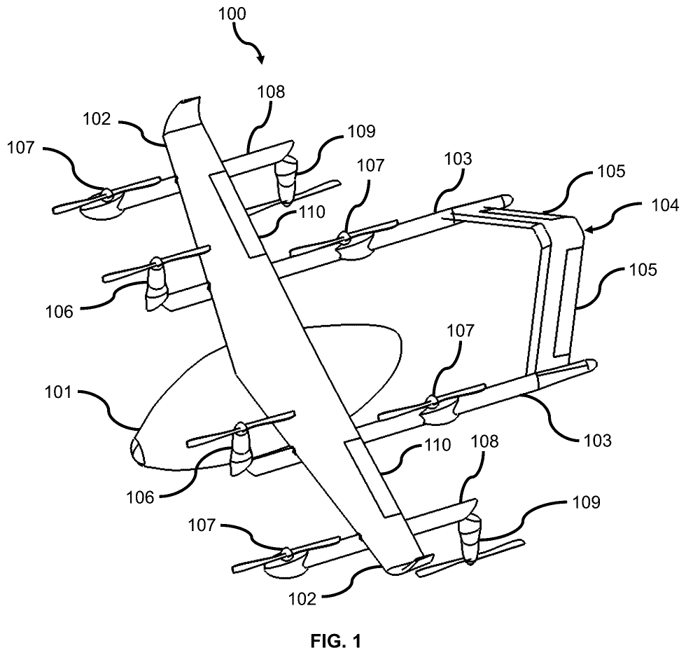

FIG. 1 shows a perspective view of the embodiment of the twin boom rotorcraft 100 in VTOL and hover mode. The rotorcraft 100 comprising of the fuselage 101, the wings 102, the inboard booms 103, the outboard booms 108, the inverted V-tail 104, the rudders 105, a plurality of proprotors 106 and 109, a plurality of lift rotors 107, and the ailerons 110. The proximal ends of the transversely extended opposing wings 102 are coupled to the longitudinally extended fuselage 101. Naturally, the center of the wings is positioned near the center of gravity of the rotorcraft along the longitudinal direction. The wings 102 are provided with the first longitudinally extended inboard booms 103 and second longitudinally extended outboard booms 108. The inboard booms 103 and outboard booms 108 comprises of a structure forward of the wings 102, and a structure aftward of the wings 102. The V-tail 104 includes a pair of opposing diagonal stabilizers. The aftward structure of the inboard booms 103 are coupled to the proximal ends of the V-tail 104. The distal ends of the diagonal stabilizers of the V-tail 104 are coupled together. The diagonal stabilizers of the V-tail 104 are provided with the rudders 105. The structure of the inboard booms 103 forward of the wings 102 is coupled through a tilt mechanism to the proprotor 106. The structure of the inboard booms 103 aftward of the wings 102 is provided with the lift rotor 107. The structure of the outboard boom 108 forward of the wings 102 is provided with the lift rotor 107. The structure of the outboard boom 108 aftward of the wings 102 is coupled through a tilt mechanism to the proprotor 109. The proprotors 106 and 109 may be provided with more than two blades with variable collective pitch capability. Moreover, the lift rotors 107 may be provided with two blades or a pair of two blades in coaxial corotating arrangement. The proprotors 106 and 109 can tilt in the pitch axis to vector rotor thrust in the vertical direction for VTOL and hover mode. The thrust of the lift rotors 107 is also contributing for vertical flight. The axis of the rotation of the lift rotors 107 and proprotor 106 or 109 may be canted from the vertical axis to minimize the damage resulting from a blade failure event (commonly referred to as rotor burst). In detail, the canted configuration allows rotor burst trajectory to avoid impacting the fuselage 101, adjacence propulsion unit and flight critical components. The opposing wings 102 are provided with the ailerons 110.

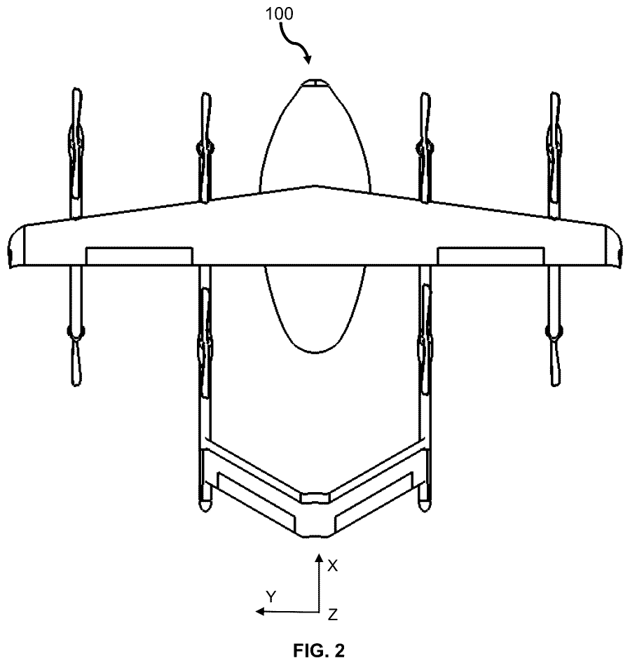

FIG. 2 shows a top orthogonal view of the twin boom rotorcraft 100 in VTOL and hover mode.

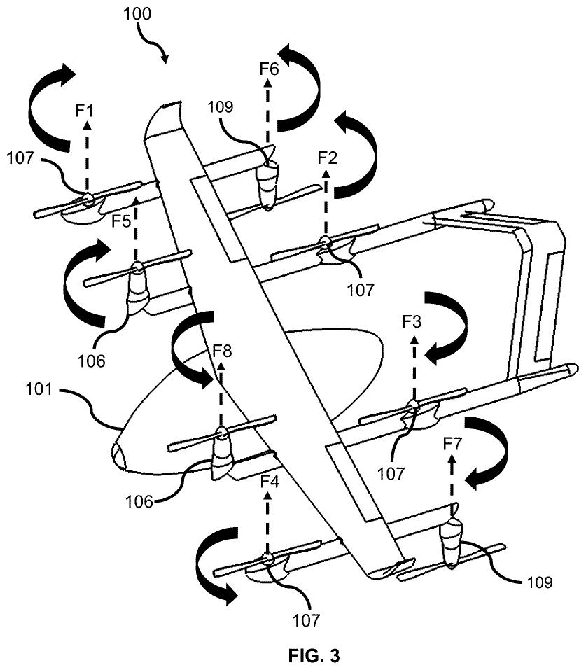

FIG. 3 shows a perspective view of the embodiment of the twin boom rotorcraft 100 in VTOL and hover mode shown with the propulsive forces. It can be observed that each one of the lift rotors 107 is configured to generate vertical lift vector F1, F2, F3, and F4. During stable vertical flight and hover, the sum of the lifting vector F1, F2, F3, and F4 generated thereby passes approximately through the center of gravity of rotorcraft 100. Similar to a quadcopter architecture, some of the lift rotors 107 rotate in opposite directions, as indicated by the curved bold arrows. As a result, the torque effect generated by lift rotors 107 substantially cancel each other out. Also shown in FIG. 3, the output thrust of the proprotor 106 and 109 is oriented vertically, therefore the thrust is represented by vertical lift vector F5, F6, F7, and F8. The sum of the lifting vector F5, F6, F7, and F8 generated thereby passes approximately through the center of gravity of the rotorcraft 100, during stable vertical flight and hover. Some of the proprotor 106 and 109 rotate in opposite directions, as indicated by the bold curved arrows, so that the torque effect generated by proprotor 106 and 109 substantially cancel each other out. Naturally, during stable vertical flight and hover, the sum of the eight lift forces F1 to F8 is intersecting the center of gravity of the rotorcraft 100. Finally, flight movements such as maintaining leveled hover, tilting in the pitch axis to fly forwards or backwards, tilting in the roll axis to fly sidewards and yawing along the vertical axis can be accomplished by modulating the magnitude of the thrust of each individual rotor.

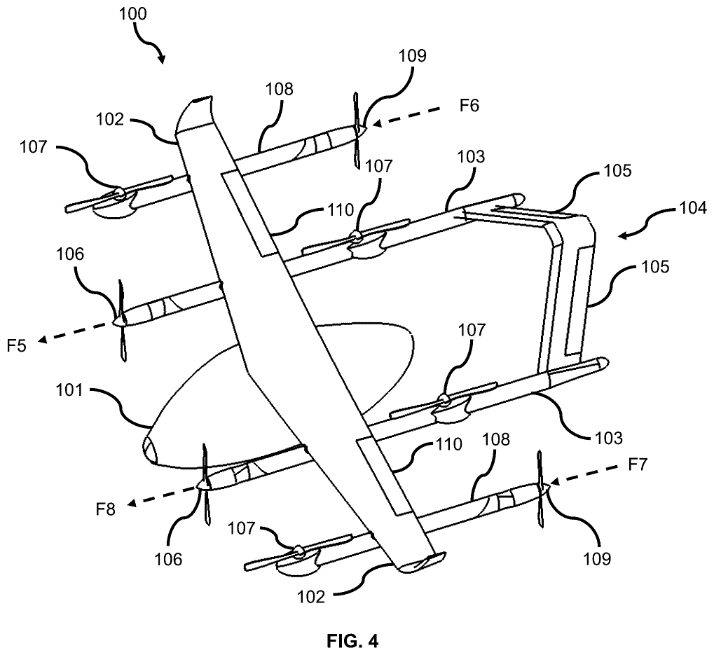

FIG. 4. shows a perspective view of the embodiment of the twin boom rotorcraft 100 in airplane mode with the propulsive forces. The rotorcraft 100 is depending on the forward speed to generate airfoil lift from the wings 102. The axis of rotation of the proprotors 106 and 109 is oriented horizontally, therefore the output thrust F5, F6, F7, and F8 are propelling the rotorcraft 100 forward. The proprotors 106 is in tractor configuration and the proprotors 109 is in pusher configuration. The lift rotors 107 are inactive and the blades are locked in position to minimized frontal area exposure to reduce drag during forward flight. The rudders 105 and ailerons 110 function as flight control surfaces to provide pitch, roll and yaw authority to the rotorcraft 100.

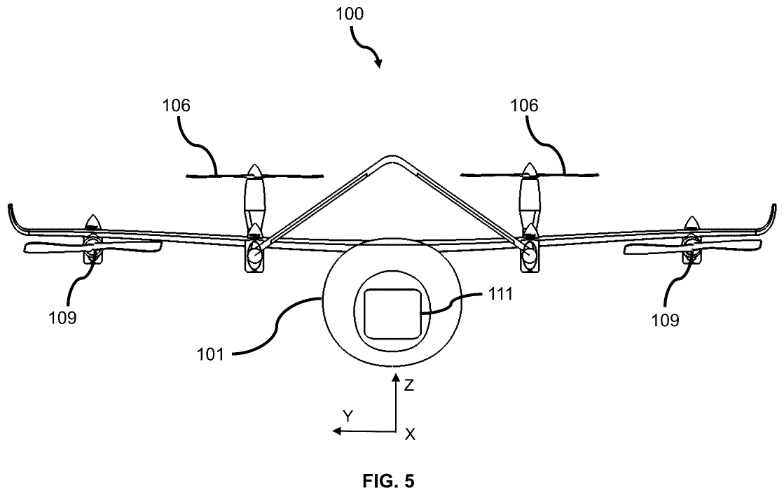

FIG. 5. shows a back orthogonal view of the of the embodiment of the twin boom rotorcraft 100 landed on ground. The proprotors 106 is oriented vertically and the proprotors 109 are oriented horizontally. This configuration of proprotors 106 and 109 allows easy ingress and egress to fuselage 101 and rear door 111.

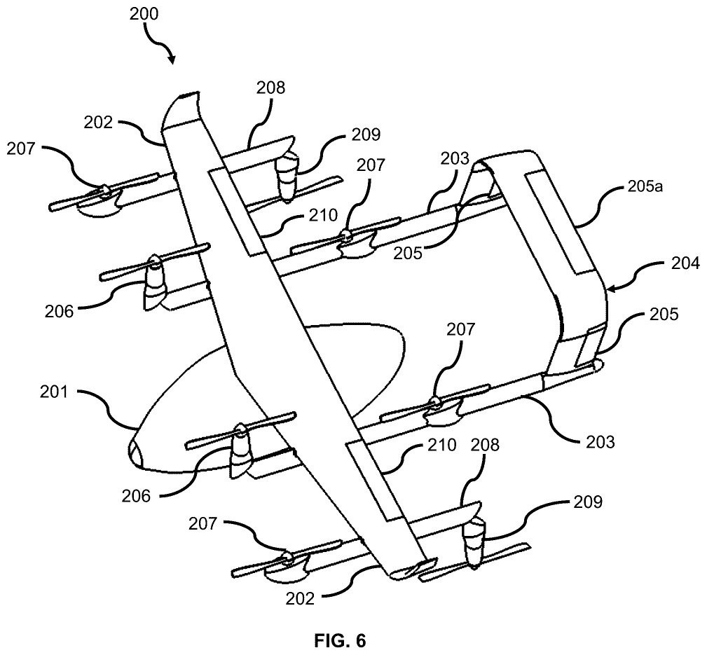

FIG. 6 shows a perspective view of the embodiment of the twin boom rotorcraft 200 in VTOL and hover mode. The rotorcraft 200 comprising of the fuselage 201, the wings 202, the inboard booms 203, the outboard booms 208, the high-tail 204, the rudders 205, the elevator 205a, a plurality of proprotors 206 and 209, a plurality of lift rotors 207, and the ailerons 210. The proximal ends of the transversely extended opposing wings 202 are coupled to the longitudinally extended fuselage 201. Naturally, the center of the wings is positioned near the center of gravity of the rotorcraft along the longitudinal direction. The wings 202 are provided with the first longitudinally extended inboard booms 203 and second longitudinally extended outboard booms 208. The inboard booms 203 and outboard booms 208 comprises of a structure forward of the wings 202, and a structure aftward of the wings 202. The high-tail 204 includes a horizontal stabilizer and a pair of opposing vertical stabilizers. The aftward structure of the inboard booms 203 are coupled to the proximal ends of the high-tail 204. The horizontal stabilizer is coupled between the distal ends of the vertical stabilizers. The opposing vertical stabilizers of the high-tail 204 are provided with the rudders 205. The horizontal stabilizer of the high-tail 204 is provided with the elevator 205a. The structure of the inboard booms 203 forward of the wings 202 is coupled through a tilt mechanism to the proprotor 206. The structure of the inboard booms 203 aftward of the wings 202 is provided with the lift rotor 207. The structure of the outboard boom 208 forward of the wings 202 is provided with the lift rotor 207. The structure of the outboard boom 208 aftward of the wings 202 is coupled through a tilt mechanism to the proprotor 209. The proprotors 206 and 209 may be provided with more than two blades with variable collective pitch capability. Moreover, the lift rotors 207 may be provided with two blades or a pair of two blades in coaxial corotating arrangement. The proprotors 206 and 209 can tilt in the pitch axis to vector rotor thrust in the vertical direction for VTOL and hover mode. The thrust of the lift rotors 207 is also contributing for vertical flight. The axis of the rotation of the lift rotors 207 and proprotor 206 or 209 may be canted away from the vertical axis to minimize the damage resulting from a blade failure event (commonly referred to as rotor burst). In detail, the canted configuration allows rotor burst trajectory to avoid impacting the fuselage 201, adjacence propulsion unit and flight critical components. The opposing wings 202 are provided with the ailerons 210.

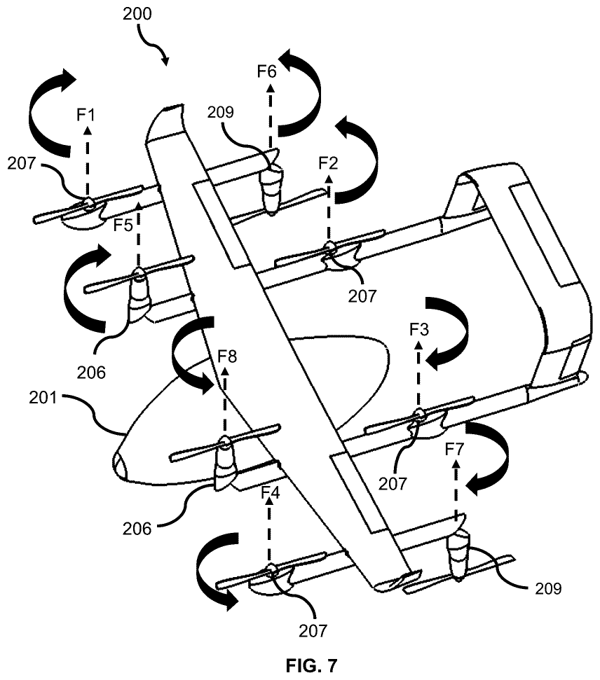

FIG. 7 shows a perspective view of the embodiment of the twin boom rotorcraft 200 in VTOL and hover mode with the propulsive forces. It can be observed that each one of the lift rotors 207 is configured to generate vertical lift vector F1, F2, F3, and F4. Moreover, each of the proprotors 206 and 209 is configurated to generate vertical lift vector F5, F6, F7, and F8. The rotorcraft 200 shares the same propulsive characteristic as rotorcraft 100 in VTOL and hover mode.

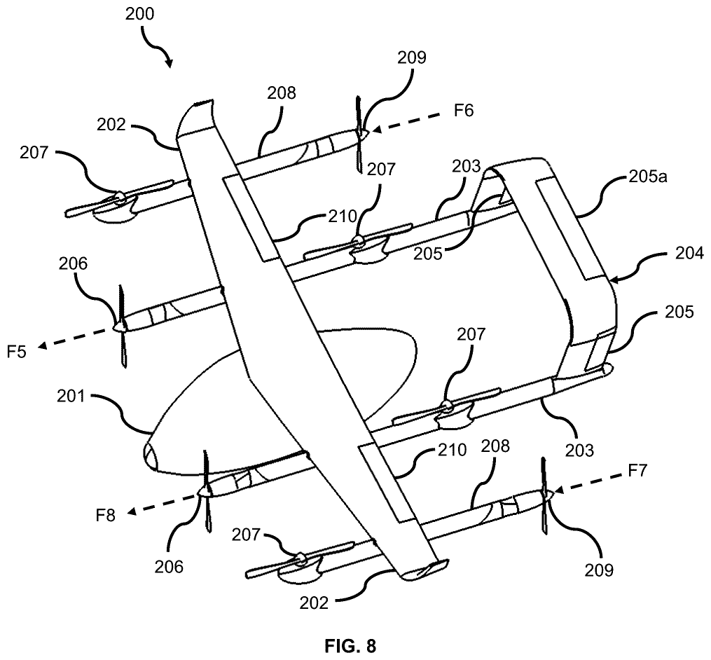

FIG. 8. shows a perspective view of the embodiment of the twin boom rotorcraft 200 in airplane mode with the propulsive forces. The rotorcraft 200 is depending on the forward speed to generate airfoil lift from the wings 202. The axis of rotation of the proprotors 206 and 209 is oriented horizontally, therefore the output thrust F5, F6, F7, and F8 are propelling the rotorcraft 200 forward. The lift rotors 207 are inactive and the blades are locked in position to minimized frontal area exposure to reduce drag during forward flight. The rudders 205, elevator 205a and ailerons 210 function as flight control surfaces to provide pitch, roll and yaw authority to the rotorcraft 200.

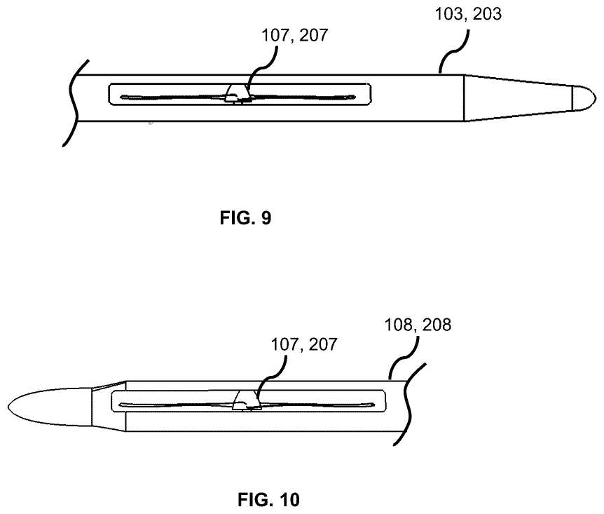

FIG. 9. shows a side orthogonal view of an optional embodiment of the inboard boom 103 or 203 provided with lift rotor 107 or 207. It can be observed that lift rotor 107 or 207 is integrated within the structure of the inboard boom 103 or 203. During airplane mode, the stowed lift rotor 107 or 207 is hidden inside the structure of the inboard boom 103 or 203, as a result a further drag reduction is achieved. Moreover, inboard boom 103 or 203 can be provided with an optional door to fully encapsule the stowed lift rotor 107 or 207.

FIG. 10. shows a side orthogonal view of an optional embodiment of the outboard boom 108 or 208 provided with lift rotor 107 or 207. It can be observed that lift rotor 107 or 207 is integrated within the structure of the outboard boom 203 or 203. During airplane mode, the stowed lift rotor 107 or 207 is hidden inside the structure of the outboard boom 108 or 208, as a result a further drag reduction is achieved. Moreover, outboard boom 108 or 208 can be provided with an optional door to fully encapsule the stowed lift rotor 107 or 207.

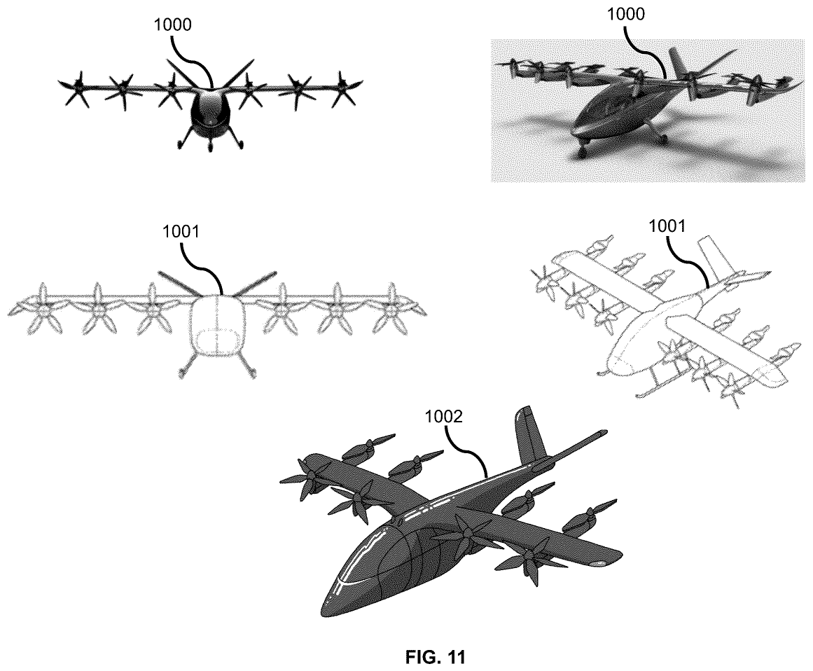

FIG. 11. are photos of existing or proposed VTOL rotorcraft designs known in the art. The examples show the possible choices of VTOL rotorcraft design from Archer Aviation 1000, Wisk Aero 1001 and Vertical Aerospace 1002. In general, the aerial vehicle design is shown with a plurality of booms coupled on the wings, and the booms are provided with a plurality of proprotors and a plurality of lift rotors.

Naturally, there are numerous variations, modifications and configurations which may be made hereto without departing from the scope of the disclosure invention. It should be understood that the embodiments are for illustrative and explanatory purpose and it is not conceivable to identify exhaustively all possible embodiments. Many other embodiments will be apparent to those of skill in the art upon reviewing the above description. During VTOL and hover flight, the placement of the four lift rotors permanently allows the rotorcraft to benefit from the reliable and agile function of a quadcopter. Moreover, the twin boom design allows an unobstructed access path to the rear door.

1. A rotorcraft adapted for vertical take-off, vertical landing and horizontal flight comprising:
a longitudinally extended fuselage;
a pair of opposing wings, each of said opposing wings having a wing proximal end and a wing distal end, wherein the proximal end of each of the wings is coupled to the fuselage;
a pair of opposing inboard booms, each of said inboard booms having a longitudinal structure forward of the wings and a longitudinal structure aftward of the wings, wherein each of the inboard booms is coupled closely to the proximal end of each wing, and the fuselage is positioned between the inboard booms;
at least one pair of opposing outboard booms, each of said outboard booms having a longitudinal structure forward of the wings and a longitudinal structure aftward of the wings, wherein each of the outboard booms is coupled closely to the distal end of each wing, and the fuselage is positioned between the outboard booms;
An inverted V-tail, wherein the inverted V-tail having opposing diagonal stabilizers with the proximal ends coupled to the aftward structure of the inboard booms, and the distal ends coupled together;
A first plurality of proprotors, wherein the proprotor is coupled on the forward structure of the inboard booms by a tilt mechanism configurated to rotate between VTOL and airplane mode;
A second plurality of proprotors, wherein the proprotor is coupled on the aftward structure of the outboard booms by a tilt mechanism configurated to rotate between VTOL and airplane mode;
A first plurality of lift rotors, wherein the lift rotor is coupled on the aftward structure of the inboard booms between the wings and the V-tail;
A second plurality of lift rotors, wherein the lift rotor is coupled on the forward structure of the outboard booms;
A pair of ailerons, wherein the ailerons are coupled to the wings by a pivot mechanism;
A pair of rudders, wherein the rudders are coupled to the diagonal stabilizers by a pivot mechanism.

2. A rotorcraft as set forth in claim 1, wherein said a plurality of proprotors can tilt on the pitch axis to direct the output thrust to the vertical direction in the VTOL configuration.

3. A rotorcraft as set forth in claim 1, wherein said a plurality of proprotors may have blades with variable collective pitch capability.

4. A rotorcraft as set forth in claim 1, wherein said a plurality of proprotors in the VTOL configuration and a plurality of lift rotors provide the vertical thrust to hover, fly up, fly down, fly forward, fly backward, fly sideway and change yaw heading.

5. A rotorcraft as set forth in claim 1, wherein said a plurality of lift rotors and proprotors in the VTOL and hover configuration can have the axis of rotation canted from the vertical axis to direct rotor burst trajectory away from critical flight components and passenger.

6. A rotorcraft as set forth in claim 1, wherein said a plurality of proprotors in the VTOL configuration has the function to improve propulsive efficiency by reducing collective disc loading.

7. A rotorcraft as set forth in claim 1, wherein said a plurality of proprotor can pivot on the pitch axis to direct the output thrust to the horizontal direction in the airplane configuration.

8. A rotorcraft as set forth in claim 1, wherein said a plurality of proprotors in airplane configuration provides the thrust for horizontal flight and said wings provide the lift force to maintain airborne.

9. A rotorcraft as set forth in claim 1, wherein said a pair of ailerons and a pair of rudders provide the flight control for pitch, roll and yaw in airplane mode.

10. A rotorcraft as set forth in claim 1, wherein said a plurality of lift rotors can be integrated within the structure of the supportive booms.

11. A rotorcraft adapted for vertical take-off and horizontal flight comprising:
a longitudinally extended fuselage;
a pair of opposing wings, each of said opposing wings having a wing proximal end and a wing distal end, wherein the proximal end of each of the wings is coupled to the fuselage;
a pair of opposing inboard booms, each of said inboard booms having a longitudinal structure forward of the wings and a longitudinal structure aftward of the wings, wherein each of the inboard booms is coupled closely to the proximal end of each wing, and the fuselage is positioned between the inboard booms;
at least one pair of opposing outboard booms, each of said outboard booms having a longitudinal structure forward of the wings and a longitudinal structure aftward of the wings, wherein each of the outboard booms is coupled closely to the distal end of each wing, and the fuselage is positioned between the outboard booms;
A high-tail, wherein the high-tail having a horizontal stabilizer and the opposing vertical stabilizers, wherein the vertical stabilizers having proximal ends coupled to the aftward structure of the inboard booms, and wherein the horizontal stabilizer is coupled to the distal ends of the vertical stabilizers;
A first plurality of proprotors, wherein the proprotor is coupled on the forward structure of the inboard booms by a tilt mechanism configurated to rotate between VTOL and airplane mode;
A second plurality of proprotors, wherein the proprotor is coupled on the aftward structure of the outboard booms by a tilt mechanism configurated to rotate between VTOL and airplane mode;
A first plurality of lift rotors, wherein the lift rotor is coupled on the aftward structure of the inboard booms between the wings and the high-tail;
A second plurality of lift rotors, wherein the lift rotor is coupled on the forward structure of the outboard booms;
A pair of ailerons, wherein the ailerons are coupled to the wings by a pivot mechanism;
A pair of rudders, wherein the rudders are coupled to the vertical stabilizers by a pivot mechanism;
An elevator, wherein the elevator is coupled to the horizontal stabilizer by a pivot mechanism.

12. A rotorcraft as set forth in claim 11, wherein said a plurality of proprotors can tilt on the pitch axis to direct the output thrust to the vertical direction in the VTOL configuration.

13. A rotorcraft as set forth in claim 11, wherein said a plurality of proprotors may have blades with variable collective pitch capability.

14. A rotorcraft as set forth in claim 11, wherein said a plurality of proprotors in the VTOL configuration and a plurality of lift rotors provide the vertical thrust to hover, fly up, fly down, fly forward, fly backward, fly sideway and change yaw heading.

15. A rotorcraft as set forth in claim 11, wherein said a plurality of lift rotors and proprotors in the VTOL and hover configuration can have the axis of rotation canted from the vertical axis to direct rotor burst trajectory away from critical flight components and passenger.

16. A rotorcraft as set forth in claim 11, wherein said a plurality of proprotors in the VTOL configuration has the function to improve propulsive efficiency by reducing collective disc loading.

17. A rotorcraft as set forth in claim 11, wherein said a plurality of proprotors can pivot on the pitch axis to direct the output thrust to the horizontal direction in the airplane configuration.

18. A rotorcraft as set forth in claim 11, wherein said a plurality of proprotors in airplane configuration provides the thrust for horizontal flight and said wings provide the lift force to maintain airborne.

19. A rotorcraft as set forth in claim 11, wherein said a pair of rudders, elevators and a pair of ailerons provide the flight control for pitch, roll and yaw in airplane mode.

20. A rotorcraft as set forth in claim 11, wherein said a plurality of lift rotors can be integrated within the structure of the supportive booms.
